(19) United States
(12) Patent Application Publication
(10) Pub. No.: US 2023/0342812 A1
(43) Pub. Date: Oct. 26, 2023

(54) SYSTEMS, METHODS AND PROGRAMMED PRODUCTS FOR DYNAMICALLY DISPLAYING CONTENT ON PUBLIC AND SEMI-PUBLIC DIGITAL DISPLAYS

(71) Applicant: Intersection Media, LLC, New York, NY (US)

(72) Inventors: Nitin Shriram, Edison, NJ (US); Benjamin Krieger, New York, NY (US)

(21) Appl. No.: 17/660,666

(22) Filed: Apr. 26, 2022

(51) Int. Cl. G06Q 30/02

(52) U.S. Cl. CPC G06Q 30/0254; G06Q 30/0245

(57) ABSTRACT

A system and method for dynamically tracking open slots that become available during looped digital content on a non-personal digital display and dynamically inserting programmatic content into the open slots by first ranking the programmatic content based on a number of parameters.

### FIELD

The present invention generally relates to systems and methods for displaying content on public and semi-public non-personal digital displays, and in particular generally relates to systems and methods for displaying looped content on public or semi-public displays in a manner that maximizes programmatic outreach.

### BACKGROUND

Digital out-of-home media, or DOOH media, refers to digital media that appears in environments accessible to the public or in semi-public settings. This includes digital billboards and outdoor signage, as well as networks of screens found in businesses like malls and healthcare providers. Examples of locations at which DOOH media may be displayed include: shopping malls and retail stores, movie theaters and arenas, medical waiting rooms, airports, train stations and bus shelters, beside major roadways, and within elevators, to name a few. DOOH media provide some important advantages over static forms of outdoor advertising, such as reduced management costs, more varied content, increased campaign creativity, and allowing for integration with other technologies such as display and facial recognition technology.

DOOH media typically plays on a loop, with much of the same material recurring after a set amount of time, such as every 8 to 10 seconds, to name a few. Conventional DOOH media algorithms involve establishing a pre-defined loop made up of slots, with each slot pre-set for a specific buyer and/or content type. To reach more people, buyers often purchase multiple slots within a single loop. As an example, a first slot within a loop may include a first programmatic advertisement, a second slot may include a public service announcement, a third slot may include a second programmatic advertisement, and a fourth slot may include a news item. The screen may be divided in that it includes designated areas for display of differing types of content, such as, for example, one area for public service advertisements and/or news items and a second area for display of advertising. In all cases, prior to displaying content, the conventional DOOH media algorithm requires the network manager to input information regarding a pre-set loop that repeats within a specific time frame, with slots already filled up within the loop. Thus, the displayed content is static in the sense that loop content does not change until the network manager inputs another loop and associated slot content, and not capable of changing dynamically in real-time.

Due to the pre-set loop and slot content, conventional DOOH media algorithms present technological barriers to real-time monitoring of information and dynamically displaying content based on the monitored information. These barriers do not allow for real-time decision making for determining what to display within each slot, and thus do not allow for dynamic display opportunities, such as, for example, capturing and display of emergency broadcasts and other urgent content in real-time. Conventional DOOH networks lack the ability to dynamically and automatically configure the slot content shown in different time slots in a loop.

Another technical challenge faced by conventional DOOH networks relates to their inability to maximize programmatic outreach. For example, if a programmatic advertisement slot is available within looped content, but no programmatic advertisement is available at the time for display in the loop, the conventional DOOH algorithm does not have any capability to request additional programmatic advertisements from potential advertisement sources. In such cases, the display algorithm relies on back up content, which is typically not revenue generating.

What is needed is a system and method by which DOOH networks can dynamically interface with potential advertisement sources and capture programmatic advertisements for display in real-time.

### SUMMARY

The present invention addresses this and other problems with new and improved computer systems and methods for tracking open slots that become available during looped digital content on a non-personal digital display and dynamically inserting programmatic content into the open slots by first ranking the programmatic content based on a number of parameters.

A method according to an exemplary embodiment of the present invention comprises: (A) calling, by one or more computers, a plurality of third party source computer systems on a periodic basis; (B) determining, by the one or more computers, with each calling in step (A), whether a response to the calling is received; (C) upon the condition it is determined in step (B) a response is received: (i) accessing, by the one or more computers, a first plurality of digital advertisements received from the called third party source computer systems; (ii) ranking, by the one or more computers, based on at least one ranking parameter, the received first plurality of digital advertisements with a prior ranked second plurality of digital advertisements corresponding to one or more of the plurality of third party source computer systems that have responded to a prior calling; (D) upon the condition it is determined in step (B) that a response is not received, accessing, by the one or more computers, the prior ranked second plurality of digital advertisements corresponding to the one or more of the third party source computer systems that have responded to a prior calling; (E) determining, by the one or more computers, whether a slot within a first play of looped content at a non-personal digital display is available for display of one of the plurality of digital advertisements, the step of determining comprising: (i) determining, by the one or more computers, whether the non-personal digital display is under a threshold of played programmatic digital advertisements at a time of the first play of the looped content; and (ii) determining, by the one or more computers, whether the slot is dedicated to a prior selected digital advertisement at the time of the first play of the looped content; (F) upon the condition that it is determined in step (E) that a slot is available within the first play of the looped content and it is determined in step (C) that a response is received, generating, by the one or more computers, instructions to display within the slot a highest ranking digital advertisement from among the first plurality of digital advertisements as ranked with the prior ranked second plurality of digital advertisements that has not yet been displayed; and (G) upon the condition that it is determined in step (E) that a slot is available within the first play of the looped content and it is determined in step (D) that a response is not received, generating, by the one or more computers, instructions to display within the slot a highest ranking digital advertisement from among the prior ranked second plurality of digital advertisements that has not yet been displayed.

In an exemplary embodiment the periodic basis is less than a duration of the first play of the looped content.

In an exemplary embodiment steps (A)-(G) are performed one or more times during the first play of the looped content.

In an exemplary embodiment the at least one ranking parameter comprises a plurality of ranking parameters.

In an exemplary embodiment the at least one ranking parameter comprises a parameter selected from the group consisting of: price, content fitness, pacing goals, and content preference.

In an exemplary embodiment the method further comprises discarding, by the one or more computers, digital advertisements from the ranked second plurality of digital advertisements.

In an exemplary embodiment the step of discarding comprises: (i) determining, by the one or more computers, one or more lowest ranked digital advertisements from the prior second plurality of digital advertisements; and (ii) eliminating, by the one or more computers, the one or more lowest ranked digital advertisements from potential play within the looped content.

In an exemplary embodiment the plurality of third-party source computer systems comprises an advertising server.

In an exemplary embodiment the plurality of third-party source computer systems comprises a third-party programmatic platform.

### DESCRIPTION OF THE DRAWINGS

Exemplary embodiments of the present invention will be described with references to the accompanying figures, wherein:

FIG. 1 illustrates an exemplary environment in accordance with exemplary embodiments of the present invention in which content is displayed on a public or semi-public non-personal digital display;

FIGS. 2A-2C show front, cross section, and top views, respectively, of an exemplary non-personal digital device that can be used in accordance with exemplary embodiments of the present invention.

FIG. 3 illustrates an exemplary configuration of participant systems and platforms in accordance with exemplary embodiments of the present invention;

FIG. 4 is a block diagram showing a conventional computer technology platform that facilitates buying and selling of media advertising inventory;

FIGS. 5A and 5B illustrate a general process flows of a method according to an exemplary embodiment of the present invention.

FIG. 6 illustrates the general process flow of a method according to an exemplary embodiment of the present invention;

FIG. 7 illustrates the general process flow of a method according to an exemplary embodiment of the present invention for fetching and ranking programmatic content from third-party programmatic sources;

FIG. 8 shows source code for a process of normalizing supply side responses according to an exemplary embodiment of the present invention;

FIG. 9A shows source code for a process for initializing recurring events according to an exemplary embodiment of the present invention;

FIG. 9B shows source code for a process of fetching ads from supply side sources (for example, as performed in steps S605 and S703 as discussed above) according to an exemplary embodiment of the present invention;

FIG. 9C shows source code for a process of ranking ads received from supply side sources according to an exemplary embodiment of the present invention;

FIG. 10 is a block diagram of an auction module according to an exemplary embodiment of the present invention;

FIG. 11 is a block diagram of a programmatic selection module according to an exemplary embodiment of the present invention;

FIG. 12 is a block diagram of a content rendering adaptor module according to an exemplary embodiment of the present invention;

FIG. 13 is a block diagram of an application program interface according to an exemplary embodiment of the present invention; and

FIG. 14 is a block diagram of a content rendering adaptor module according to an exemplary embodiment of the present invention.

### DETAILED DESCRIPTION

The present invention generally relates to systems and methods for dynamically capturing and analyzing information, such as, for example, information regarding slots that become dynamically available during plays of looped content and programmatic content that may be dynamically inserted into the available slots, and displaying the looped content on public or semi-public non-personal digital displays so that such information may be made available to viewers in real-time or near real-time while optimizing the accessibility and effectiveness of the display of such information.

For the purposes of the present disclosure, the term “real time” means at or very near the time (e.g., within 2 seconds, within 5 seconds, etc.) at which an event occurs and/or notification of the event is received.

In embodiments, the present invention seeks to address the technological problem of how to track and display information on non-personal digital displays in a dynamic manner within looped content that is otherwise pre-set. Conventionally, the manner in which content is displayed is predetermined by a network content manager, so that looped content for instance is fixed until the content is altered at some later point in time. This is problematic particularly in the case of open slots which may become available during a loop play (e.g., when content is not available from a third-party programmatic source), often resulting in play of fall back content within the open slot or no play of content at all.

In exemplary embodiments, the present invention addresses the technological challenge of how to reserve impressions on computer networks of digital out-of-home advertising kiosks for third party variably available content sources. For example, when impressions are reserved on kiosks, there is no knowledge regarding know how many impressions the content sources will be able to serve. In general, what is known at ad play time is if those content sources have content, and if no content from third party sources is available at that time, impressions allocated to ad plays are wasted on filler content. There is a technological problem in that non-personal digital displays currently are not capable of dynamically retrieving revenue-generating content for insertion into slots within looped content that may become available during each loop play.

In exemplary embodiment, the present invention addresses this technological problem by establishing a computer system outside of the impression reservation system, that continuously pulls content from the variably available content sources. In embodiments, when content becomes available to play, the content is placed in a content queue to be played on the screen so that if a slot becomes available during a specific loop play, content can be selected from the queue and inserted dynamically into the available slot. In embodiments, before the next ad fetch a proof-of-play queue may be checked, the proof-of-play may be resolved by notifying third parties, and then the ad may be removed from the ad queue.

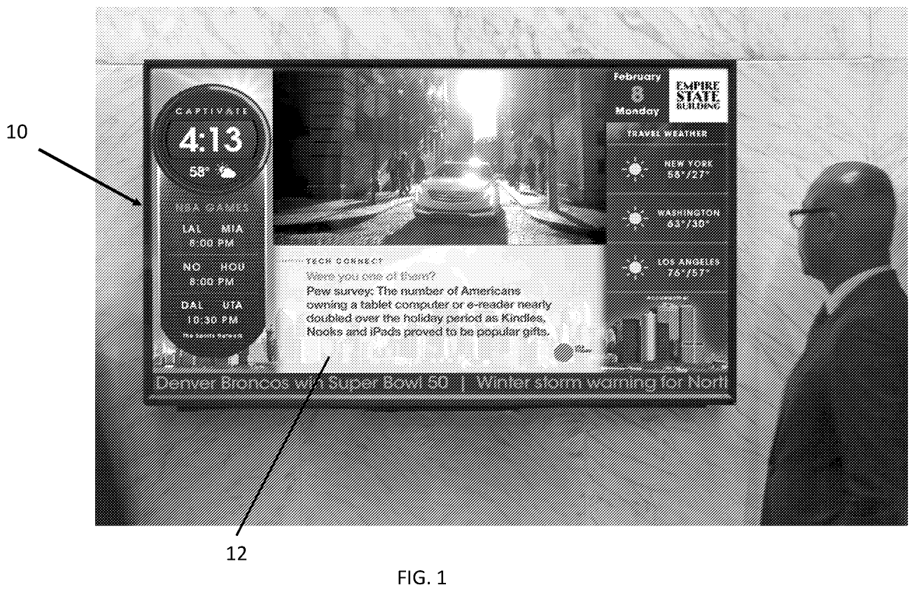

FIG. 1 illustrates an exemplary environment in accordance with the exemplary embodiments of the present invention in which digital content is displayed on a network-connected non-personal digital device 10. The digital content may include digital messages (e.g., text messages, image messages, video messages, audio-video messages and/or a combination thereof, to name a few) played automatically on the non-personal digital device 10 in accordance with a pre-defined loop that repeats within a predetermined time period. In accordance with exemplary embodiments of the present invention, at least some of the content displayed within each repeating time period is not part of the pre-set loop content. For example, such content may be externally sourced in a dynamic manner so that the content is changed in real time depending on queued content, and in a preferred exemplary embodiment, the queued content is received from programmatic ad sources.

By way of example, FIG. 1 illustrates digital content is displayed on a monitor 12 of non-personal digital device 10. Monitor 12 includes a screen that may be configured as a split-screen so that different types of content are displayed in each section of the screen. The middle of the screen may display advertisements (programmatic or otherwise), the sides of the screen may display general information such as, for example, date, time, and local temperature, to name a few, and/or news items such as, for example, sports scores, stock market information, and weather forecasts, to name a few. The bottom of the screen may be designated to display more recent and/or urgent information, such as, for example, recent major event information (e.g., Super Bowl and other major sporting event scores, election results, etc.) and/or public service announcements, such as, for example, traffic alerts, storm warnings, and other types of urgent information. Other configurations may also be used consistent with the spirit and scope of the present invention.

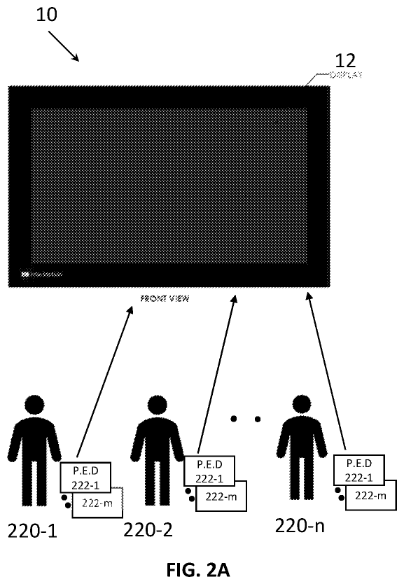

While FIG. 1 represents non-personal digital device 10 as digital signage affixed to a wall in a public or semi-public place, other non-personal network-connected digital devices and electronic displays in public and semi-public settings can also be used in accordance with exemplary embodiments of the present invention, such as the digital urban panel shown in FIGS. 2A-2C (discussed below). For example, network-connected screens on non-personal digital devices can be placed in transit stations and platforms, airports, building lobbies, elevators, on the exterior or in the interior of a motor vehicle, in retail or commercial locations such as malls, grocery stores, restaurants, movie theaters, and health clubs, on outdoor digital billboards and street signs, and/or on digital map/wayfinding displays, to name a few.

FIGS. 2A, 2B, and 2C show front, cross-section, and top views, respectively, of an exemplary non-personal digital device 10 that can be used in accordance with exemplary embodiments of the present invention. As illustrated in FIGS. 2A-2C, non-personal digital device 10 includes a monitor 12 electrically connected to LCD 202 (liquid crystal display) on which the digital advertisement may be displayed. LCD 202 is used in an exemplary manner. Other types of display circuitry may be used, such as, for example, cathode ray tubes (CRTs), light emitting diodes (LEDs), e-paper and organic light emitting diodes (OLEDs), to name a few. As shown in FIG. 2A, in embodiments, monitor 12 may be a touch screen, allowing one or more individuals 220-1, 220-2 . . . 220-n to interact with the non-personal digital device 10. Monitor 12, in embodiments, may include a resistive touch screen, a capacitive touch screen, a surface acoustic wave touch screen, an infrared touch screen, an optical imaging touch screen, or an acoustic pulse recognition touch screen, to name a few.

Non-personal digital device 10 may also include a network connection, such as network switch 208, antenna (which may be located in the antenna compartment 212 and/or accessible via the fiber knockout 214) as shown in FIGS. 2B and 2C, by way of example. Other types of network connections such as cellular modems using GPRS, EDGE, 3G, 4G LTE, low power LTE, Ethernet, token-ring, Wi-Fi, WiMAX, Bluetooth®, ZigBee, fixed-point wireless, mesh networks, GSM, GSM-R, UMTS, TD-LTE, LTE, LTE-Advanced Pro, LTE Advanced, Gigabit LTE, CDMA, iDEN, MVNO, MVNE, Satellite, TETRA, WiMAX, AMPS TDMA, Roaming SIM, DC-HSPA, HSPA, HSPA+, HSDPA, G, 2G, 3.5G, 4G, 4.5G, 5G, 5.5G, 6G, 6.5G, GNSS, EV-DO, 1×RTT, WCDMA, TDS-CDMA, CDMA2000, CSFB, FDMA, OFDMA, PDMA, AMPS, EV-DO, DECT, IS-95, NMT, UMTS, MPLS, MOCA, Broadband over Power Lines, NB-IoT, enhanced MTC (eMTC), LTE-WLAN, ISDN, Microwave, Long Range Wi-Fi, Point to Point Wi-Fi, EC-GSM-IoT, LTE-M, NB-IoT, Evolved Multicast Broadcast Multimedia Service (eMBMS) and LTE-Broadcast (LTE-B), or other data transmission technologies, to name a few, may also be used in accordance with exemplary embodiments of the present invention.

In exemplary embodiments, non-personal digital device 10 may offer other features such as an interactive screen or a display of non-advertising information, to name a few. In embodiments where non-personal digital device 10 includes a touch screen, tablet or other consumer-operated interactive capability, an event can also be tracked and linked to an individual impression when a consumer takes some action (e.g., purchasing a product) via an interactive capability on the non-personal digital device 10 and the non-personal digital device 10 sends a message to a measurement module registering the event.

By way of example, non-personal digital device 10 may further include service CPU 204, CPU 206, and power supply 210. Service CPU 204 may allow an individual or manufacturer of non-personal digital device 10 to fix or troubleshoot non-personal digital device 10. CPU 206 may include an operating system or other software that provides executable display instructions to the operatively connected LCD 202. Service CPU 204 and CPU 206 may include: one or more processors, memory circuitry (including RAM and/or ROM), a display (which may be similar to LCD 202), communications circuitry, input circuitry, and/or output circuitry, to name a few. The components of non-personal digital device 10 (e.g., monitor 12, network switch 208, service CPU 204, CPU 206, etc.) may be electronically and/or operatively connected to the power supply 210 (which may be accessible via power knockout 216).

As shown in FIG. 2A, at any given period in time, an individual 220-1 . . . 220-n, who may possess one or more personal electronic devices 222-1 . . . 222-m such as, mobile computers (e.g., laptops, Ultrabooks™), desktop computers, mobile phones, smart phones, tablets, personal display devices, personal digital assistants (“PDAs”), gaming consoles and/or devices, smart vehicles (e.g., cars, trucks, motorcycles, etc.), and/or wearable devices (e.g., watches, pins/broaches, headphones, etc.), to name a few, may take some action (e.g., visit a website, download an application, purchase a product, etc.) related to a product or service promoted in the digital advertisement being displayed on the non-personal digital device 10. In accordance with exemplary embodiments, a programmatic module (either third-party or otherwise) may be used to link other forms of digital advertising (e.g., online, mobile, social, etc.) with digital advertising on the non-personal digital device 10. Examples of such programmatic modules are described in U.S. patent application Ser. No. 16/054,516 (now U.S. Pat. No. 10,740,786) and Ser. No. 16/353,550 (now U.S. Pat. No. 10,504,158), the contents of which are incorporated herein by reference in their entirety. The programmatic module allows digital ad buying systems (e.g., “demand side platforms”, “DSPs”, “ad servers” or “bidders”) to purchase the opportunity to display a digital advertisement on a non-personal digital device in a public or semi-public setting, using an adaptation of electronic bidding that enables the platforms to track and measure the exposure to individual consumers (“individual impressions”) associated with the display of that advertisement, and also enables an array of operations within the digital ad buying system or other integrated measurement platforms, including, e.g., planning, reporting, attribution, analytics, and campaign optimization.

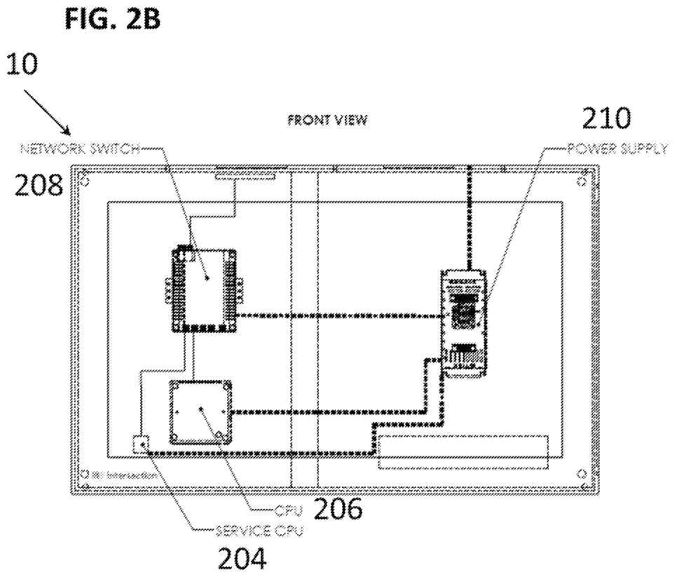

FIG. 3 illustrates an exemplary configuration of participant systems and platforms in accordance with exemplary embodiments of the present invention. It will be appreciated that each of the devices, systems and platforms illustrated in FIG. 3 are represented as a single unit but may be comprised of one or more units or may be parts of a larger aggregated unit that performs multiple functions.

As illustrated in FIG. 3, components of the computer system in accordance with exemplary embodiments may include an auction module 310, a programmatic selection module 320, a rules module 330, a content rendering adaptor module 340 and an application program interface 350. These components may be connected either directly, indirectly and/or through a network connection (such as the Internet, a near field wireless connection, a cellular network connection, or a wireless local area network) and interact (also either directly, indirectly and/or via wired network and/or wireless near field and/or cellular connections) with other devices, systems and platforms within an operating environment to carry out the various aspects of the present invention. For example, the operating environment may include third party programmatic platforms 360-1-360-m, third party content consumers 370-1-370-n, content rendering applications 380-1-380-o, and ad servers 390-1-390-p, to name a few. Although auction module 310, programmatic selection module 320, rules module 330, content rendering adaptor module 340 and application program interface 350 are shown as separate components, it should be appreciated that these components may be incorporated into modules of one or more components or may be embodied in a single component having all of the functionality of these components. Further, it should be appreciated that these components may be associated with a computer-readable medium coupled to one or more data processing apparatus having instructions stored thereon which, when executed by the one or more data processing apparatus, cause the one or more data processing apparatus to perform the processes described herein. As shown by the dashed-line outline in FIG. 3, auction module 310, a programmatic selection module 320, a rules module 330, a content rendering adaptor module 340 and an application program interface 350 may be collectively referred to herein as playlist optimizer system 300. In embodiments, playlist optimizer system 300 may have less than each of these modules, and/or may include other modules not shown in FIG. 3.

In exemplary embodiments, the playlist optimizer system 300 may be a component of a non-personal digital device, such as the non-personal digital device 10 described above. Thus, as described in more detail below, the non-personal digital device may have the capability to dynamically select with each content loop the optimal content to play within available slots so as to optimize programmatic revenue.

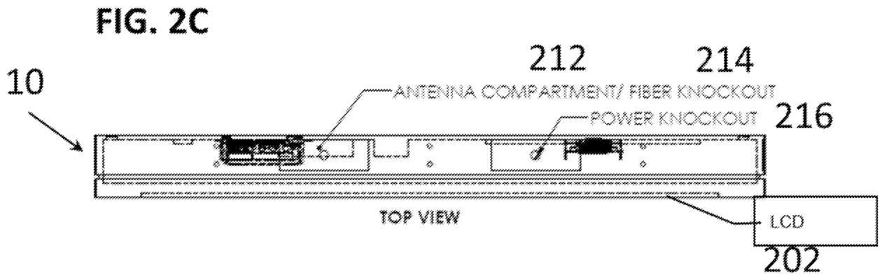

FIG. 4 is a block diagram showing a conventional computer technology platform, generally designated by reference number 2000, that facilitates buying and selling of media advertising inventory. The platform includes one or more ad exchange computer systems 2008-1-2008-q in communication with one or more supply side sources and one or more buyer side sources. The buyer side sources may include, for example, advertiser computer systems 2002-1-2002-r, an agency computer system 2004, and a demand side platform 2006, to name a few. The supply side sources may include, for example, supply side platforms 2010-1-2010-s and publisher computer systems 2012-1-2012-t, to name two. In operation, the ad exchange computer systems 2008-1-2008-q enables advertisers and publishers to buy and sell advertising space, typically through real-time auctions. Communication may be over one or more networks, such as the Internet or a private network. Examples of ad exchange computer platforms include Google Ad Exchange, MoPub, OpenX, Pubmatic, and Xandr, to name a few.

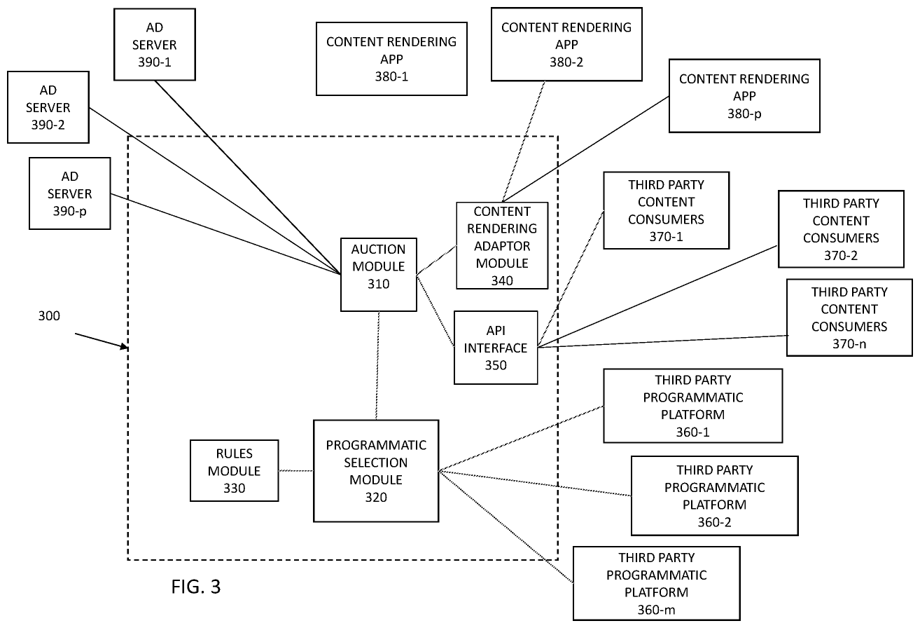

FIGS. 5A and 5B illustrate a general process flow of a method according to an exemplary embodiment of the present invention. In embodiments, the inventive computer system continuously ranks ads received from supply side sources and dynamically places highest-ranked ads into a content loop at a non-personal digital display based on availability of space within the loop with each loop play. This obviates the need for the non-personal digital display to rely on fall back content in the event of an empty slot appearing the loop, and instead a revenue-generating programmatic ad may be played in the available slot.

More specifically, in Step S501 of the process, the playlist optimizer system 300 may fetch one or more ads from supply side sources, which may be, for example, third party programmatic platforms 360-1-360-m, third party content consumers 370-1-370-n, content rendering applications 380-1-380-o, and ad servers 390-1-390-p, to name a few. The fetch process may occur on a periodic basis, such as, for example, every 3 seconds, every 5 seconds, every 10 seconds, to name a few. In embodiments, multiple fetch process may occur within each play of the looped content to account for potentially multiple slots opening during the loop. With each fetch, the system 300 in Step 503 may re-rank the ads (assuming new ads are received) or reference a prior ranking if no new ads are received in the current fetch or call. In this regard, in Step S505, each ad data may need to be normalized to allow for comparison and ranking of the ads. Normalizing may include, for example, identifying or assigning an ad ID, identifying or assigning a version of the ad, identifying a source of the ad (e.g., a specific supply side platform), identifying creative metadata (e.g., width, height, media type and url, to name a few), collecting advertiser data (e.g., name of advertiser), identifying or assigning a deal name, collecting an auction price, collecting a bid price and by referencing a POP token, to name a few.

In Step 507, the playlist optimizer system 300 may determine with each fetch if the current ad loop has an available slot in which the highest ranked ad may be played. If there is an open slot during any of the time periods over the course of the loop, the playlist optimizer system 300 at Step S511 may insert the highest ranked ad into the that open slot. As described in more detail below, the ranking may be based on a number of parameters, such as, for example, price, pacing, content fitness, and source priority, to name a few. Prior to the insertion of the ad, the playlist optimizer system 300 at Step 509 may ensure proof of play to advertisers that provided ads in prior available slots in the loop.

FIG. 5B shows the fetch/rank/insertion process occurring every X seconds during one loop play, and in the specific example shown, indicates a programmatic ad was received and inserted for play in a slot that became available during the second time period. In other time periods, as also shown in this specific example, no ads were received in response to the corresponding call, in which case the non-personal digital display either had an empty slot or needed to rely on fall back content. It should be appreciated that in exemplary embodiments an ad may be inserted into an empty slot in the case in which the ad was not fetched during the current time period but was instead received in a prior time period and placed in a queue of ranked content.

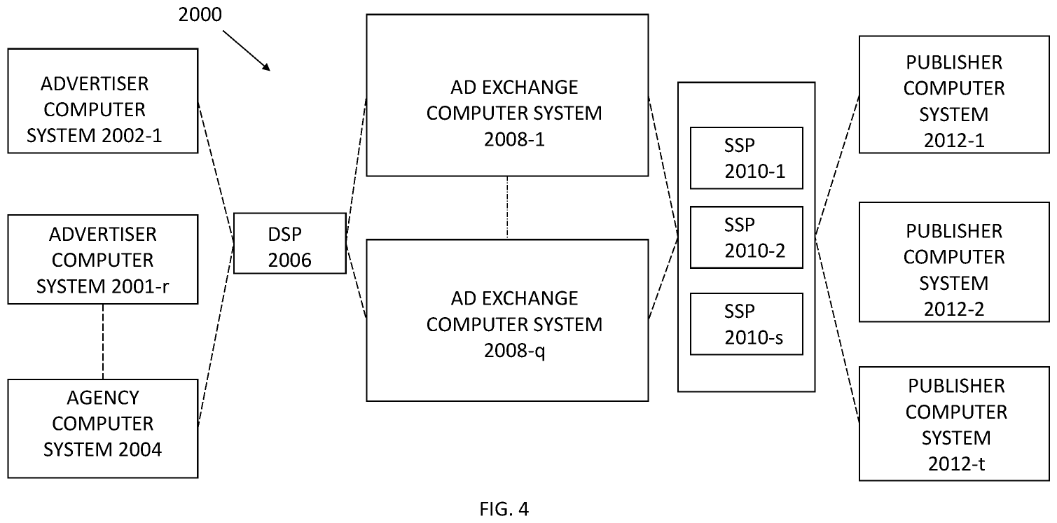

FIG. 6 illustrates the general process flow of a method according to an exemplary embodiment of the present invention. In Step S601 of the method, a timer may be set for the auction module 310 to call for supply side content. For example, supply side content may be called at a set time period, where the set time period may depend on, for example, the length of time for a single loop of content. In a specific example, if the looped content plays every 30 seconds, the auction module 301 may obtain supply side content every 3, 5, 10, or 20 seconds, for example, so that the auction module 310 has sufficient time to dynamically determine slot availability in the loop play and what content to play in the available slots. In embodiments, one or more slots may be become available during each loop, so that if programmatic content is available, such content can be played in or more of the empty slots.

In Step S603, at the end of the predetermined time period, the timer may be set back to the beginning of another time period (e.g., set back to 0 seconds) and then at step S605 the auction module 310 may call for supply side content. In exemplary embodiments, the supply side content may be called from a variety of sources, such as, for example, third party programmatic platforms 360-1-360-m, third party content consumers 370-1-370-n, content rendering applications 380-1-380-o, and ad servers 390-1-390-p, to name a few. Third party programmatic platforms 360-1-360-m may include, for example, supply side platforms and/or demand side platforms, to name two.

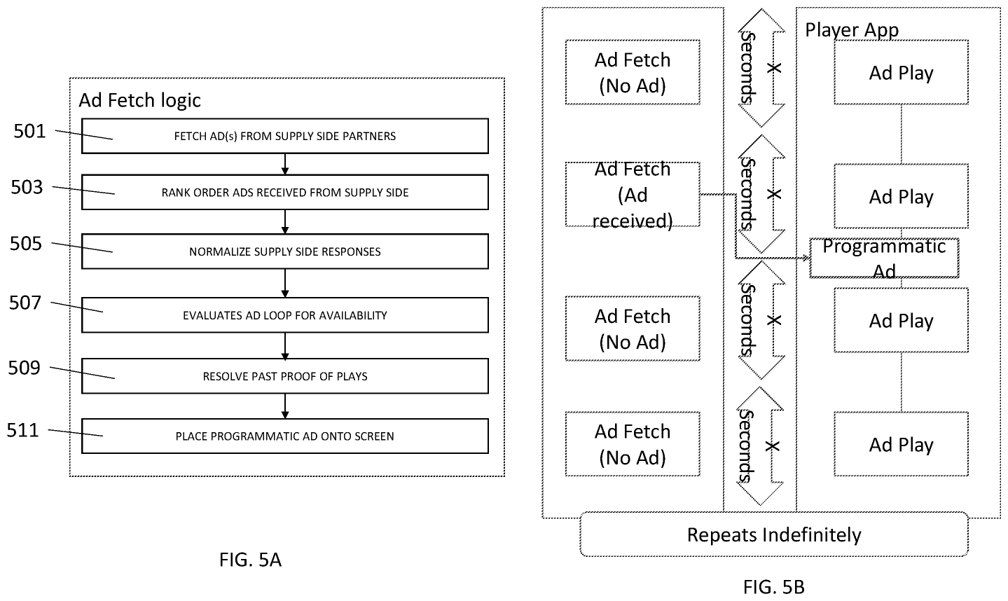

In exemplary embodiments, any content received from third party programmatic platforms 360-1-360-m in response to the call from the auction module 310 is pre-filtered by the programmatic selection module 320 based on a set of rules established in the rules module 330. FIG. 7 illustrates the general process flow of a method according to an exemplary embodiment of the present invention for pre-filtering the content sources from the third-party programmatic platforms 360-1-360-m. In Step S701, the programmatic selection module 320 determines whether a call is received from the auction module for programmatic content. This check may occur on a periodic or aperiodic basis, for example, every 5 seconds, every 10 seconds, etc, depending on, for example, the set time period at which the auction module 310 makes a call for content. If it is determined that a call is received, the process may continue to step S703, where the programmatic selection module 320 may call programmatic sources, such as, for example, supply side platforms and/or demand side platforms, for programmatic ad content.

The process then continues to Step S705, where the programmatic selection module 320 may determine if any responses to the call to the programmatic sources are received. If no, then the programmatic selection module 320 in Step S707 may select the high-ranked content in a programmatic content queue of programmatic content that was already sourced and ranked in a prior iteration of the process. Otherwise, in Step S5709 the programmatic selection module 320 may rank any new programmatic content with programmatic content already in the programmatic content queue to determine a new programmatic content ranking. In this regard, the programmatic selection module 320 may accesses a set of rules established at the rules module 330, where the set of rules are configured to rank supply side content including programmatic content. The set of rules may be based on, for example, price, pacing, content fitness, and source priority, to name a few. In Step S709, the programmatic selection module 320 may apply the rules to the third party programmatic platform sourced-content to determine preferred programmatic content. For example, if the third party programmatic platforms 360-1-360-m include multiple supply side platforms, the programmatic selection module 320 may rank the content received from each of the supply side platforms in accordance with the set of rules. More specifically, even if an advertiser may place a winning bid with one of the supply side platforms, the programmatic selection module 320 may determine that another ad associated with a winning bid from another supply side platform should be ranked higher because, for example, the price of that winning bid is higher, and/or presenting the ad associated with that winning bid better conforms with a pacing demand, and/or the ad associated with that winning bid has better content fitness, and/or the source (e.g., advertiser and/or supply side platform) has a preferred status, to name a few.

After ranking the new programmatic content with the prior programmatic content, the programmatic selection module 320 in Step S711 may select the highest ranked programmatic content (which may be newly sourced programmatic content or higher ranked content that was already sourced in a prior iteration) for display. The lower-ranked programmatic content may be placed in the queue for the next iteration of the process (step S713). Then, in Step S715, the programmatic selection module 320 may send or otherwise make accessible to the auction module 310 the highest ranked programmatic content determined in Step S711 or the highest ranked programmatic content in the queue determined in Step S707.

Returning to FIG. 6, in Step S607, the auction module 310 may determine if any new supply side content is received. If no, the process may continue to step S609, where the auction module 310 may select the high-ranked content in a supply side content queue of supply side content that was already sourced and ranked in a prior iteration of the process. This queue may include ranked content from a variety of sources including, for example, third party programmatic platforms 360-1-360-m (as previously sourced by the programmatic selection module 320), third party content consumers 370-1-370-n, content rendering applications 380-1-380-o, and ad servers 390-1-390-p, to name a few. In this regard, the auction module 310 may access a set of rules established at the rules module 330, where the set of rules are configured to rank supply side content. The set of rules may be based on, for example, price, pacing, content fitness, and source priority, to name a few. In embodiments, the set of rules used to rank supply side content in general may be the same or different from the set of rules used to rank programmatic content specifically. For example, programmatic content ranking may be based only on one or a subset of parameters, while supply side content in general may be ranked by a combination of all the parameters.

If it is determined in Step S607 that new supply side content is received, the auction module 310 in Step S611 may conduct a “secondary auction” by applying the supply side content ranking rules to determine ranking of the new supply side content with any other supply side content already in the queue of supply side content that was sourced in prior iterations of the process. As an example, highest ranked programmatic content as determined in the process of FIG. 7 may be ranked with other supply side content, such as, for example, content received from third party content consumers 370-1-370-n, content rendering applications 380-1-380-o, and/or ad servers 390-1-390-p, to name a few, to determine a new overall ranking of all supply side content at that time.

Then, at Step S613, the auction module 310 may select the highest ranked supply side content for display and at step S615 place the lower ranked supply side content in the queue for the next iteration of the process.

At Step S617, the auction module 310 may determine if there is availability in the current loop for display of supply side content. In this regard, rather than relying on a selection of non-revenue generating fall back content to play in a blank slot, the auction module 310 may recognize that a blank slot has opened in the current loop and select revenue-generating content for display in that slot. If a slot is available, the auction module 310 at Step S619 may send instructions to the display to play the highest ranked supply side content in the slot instead of the fall back content. Otherwise, the auction module 310 may wait at Step S621 until expiration of the set time period (e.g., 3, 5, 10 or 20 seconds) to again iterate through the process to determine a highest-ranked supply side content to play in an available slot (if there is one).

In embodiments, playlist optimizer module 300 may establish a set of priority and overall system-wide rules that ultimately determine what is seen on each screen at any moment in time. In this regard, in embodiments, playlist optimizer module 180 may reference the ranking rules as well as rules from other sources that also may want to display content and advertising on that display. Examples of these other sources include, for example, an advertising server 320 (e.g., Broadsign) or a third-party programmatic platform 330 (e.g., PlaceExchange), to name a few. In embodiments, playlist optimizer module 180 may be ultimately responsible for deciding, in real time, what should be displayed, even when it has competing requests and rules from multiple inputs.

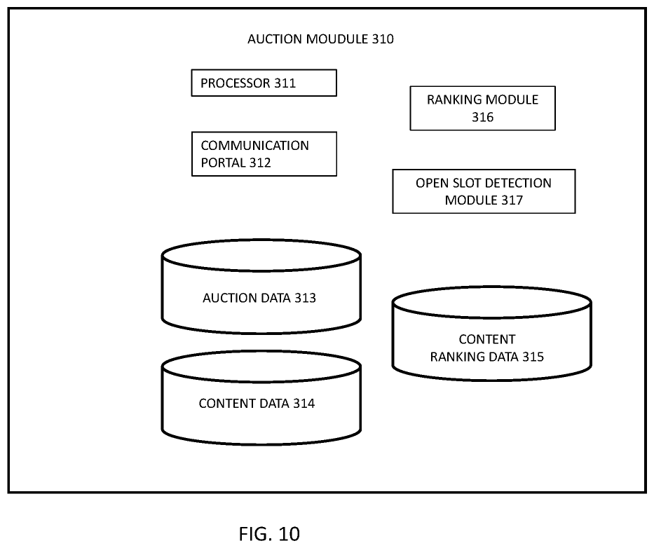

In embodiments, auction module 310 may include computer hardware and/or software components that are configured to fetch content, such as, for example, programmatic content, from a variety of sources, rank the content to form a queue of content, determine open slots in looped content, and generate instructions to insert the ranked content from the queue into the open slots in a dynamic manner. As shown in FIG. 10, the auction module 310 may include one or more processors 311 and a communication portal 312 (e.g., for sending and/or receiving data). The one or more processors 311 may include one or more processing devices such as, for example, a microprocessor, a microcontroller, an application-specific integrated circuit (ASIC), a field programmable gate array (FPGA) or other type of processing circuitry, as well as portions or combinations of such circuitry elements. Auction module 310 can also include non-transitory computer-readable memory with one or more databases and data stored thereon. The memory may comprise electronic memories such as random-access memory (RAM), read-only memory (ROM), or other types of memory, in any combination. Data stored on the memory can include, for example, auction data 313, content data 314 and content ranking data 315, to name a few. One or more software modules may be stored in the memory and running or configured to run on the one or more processors 311. Such modules can include, for example, a ranking module 316 and an open slot detection module 317, to name two. The processes performed by such modules, the data produced thereby and/or the data accessed thereby are described herein.

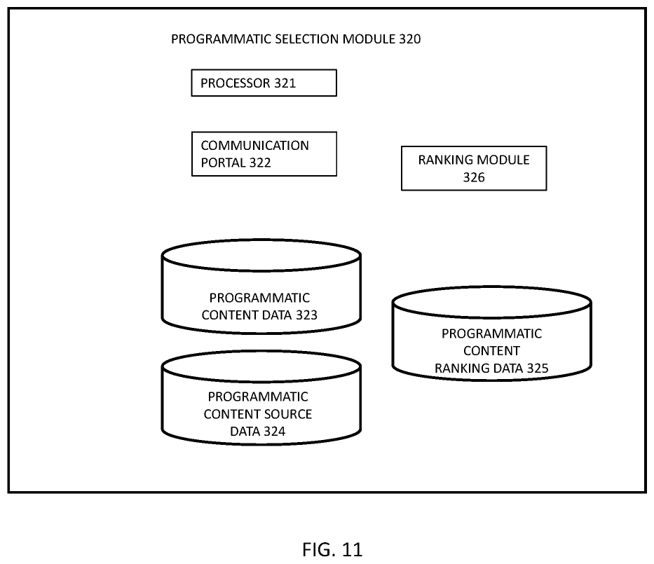

In embodiments, programmatic selection module 320 may include computer hardware and/or software components that are configured to fetch programmatic content from a variety of programmatic content sources, rank the content to form a queue of content, and send highest ranked programmatic content to the auction module. As shown in FIG. 11, the programmatic selection module 320 may include one or more processors 321 and a communication portal 322 (e.g., for sending and/or receiving data). The one or more processors 321 may include one or more processing devices such as, for example, a microprocessor, a microcontroller, an application-specific integrated circuit (ASIC), a field programmable gate array (FPGA) or other type of processing circuitry, as well as portions or combinations of such circuitry elements. Programmatic selection module 320 can also include non-transitory computer-readable memory with one or more databases and data stored thereon. The memory may comprise electronic memories such as random-access memory (RAM), read-only memory (ROM), or other types of memory, in any combination. Data stored on the memory can include, for example, programmatic content data 323, programmatic content source data 324 and programmatic content ranking data 325, to name a few. One or more software modules may be stored in the memory and running or configured to run on the one or more processors 321. Such modules can include a programmatic content ranking module 326, for example. The processes performed by such modules, the data produced thereby and/or the data accessed thereby are described herein.

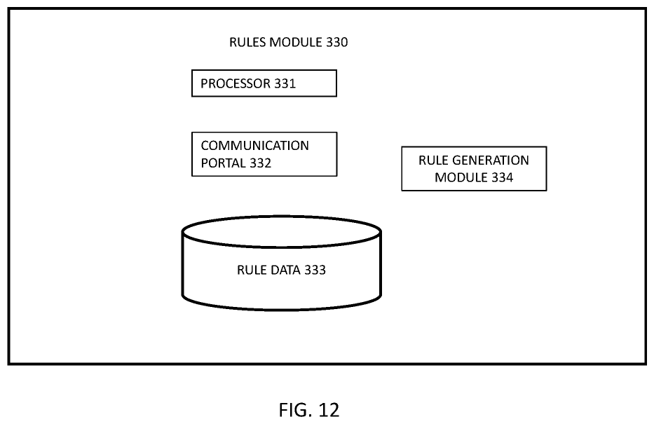

In embodiments, rules module 330 may include computer hardware and/or software components that are configured to generate and store rules used to determine rank of content to be dynamically inserted into empty slots during loop plays. As shown in FIG. 12, the rules module 330 may include one or more processors 331 and a communication portal 332 (e.g., for sending and/or receiving data). The one or more processors 331 may include one or more processing devices such as, for example, a microprocessor, a microcontroller, an application-specific integrated circuit (ASIC), a field programmable gate array (FPGA) or other type of processing circuitry, as well as portions or combinations of such circuitry elements. Rules module 330 can also include non-transitory computer-readable memory with one or more databases and data stored thereon. The memory may comprise electronic memories such as random-access memory (RAM), read-only memory (ROM), or other types of memory, in any combination. Data stored on the memory can include, for example, rule data 333. One or more software modules may be stored in the memory and running or configured to run on the one or more processors 331. Such modules can include a rules generation module 334, for example. The processes performed by such modules, the data produced thereby and/or the data accessed thereby are described herein.

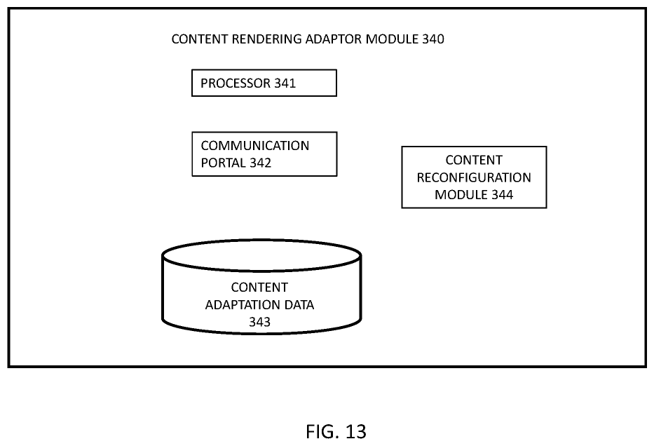

In embodiments, the content rendering adaptor module 340 may include computer hardware and/or software components that are configured to receive content rendered from application software and adapt the content for display on a non-personal digital device. As shown in FIG. 13, the content rendering adaptor module 340 may include one or more processors 341 and a communication portal 342 (e.g., for sending and/or receiving data). The one or more processors 341 may include one or more processing devices such as, for example, a microprocessor, a microcontroller, an application-specific integrated circuit (ASIC), a field programmable gate array (FPGA) or other type of processing circuitry, as well as portions or combinations of such circuitry elements. Content rendering adaptor module 340 can also include non-transitory computer-readable memory with one or more databases and data stored thereon. The memory may comprise electronic memories such as random-access memory (RAM), read-only memory (ROM), or other types of memory, in any combination. Data stored on the memory can include, for example, content adaption data 343. One or more software modules may be stored in the memory and running or configured to run on the one or more processors 341. Such modules can include a content reconfiguration module 344, for example. The processes performed by such modules, the data produced thereby and/or the data accessed thereby are described herein.

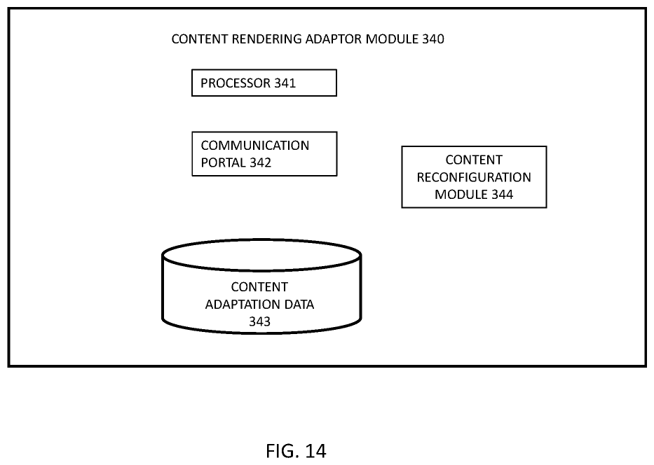

In embodiments, the API interface 350 may include computer hardware and/or software components that are configured to allow third party platforms and computer systems, such as, for example, third party content consumer computer systems, to interface with the playlist optimizer system 300. As shown in FIG. 14, the API interface module 350 may include one or more processors 351 and a communication portal 352 (e.g., for sending and/or receiving data). The one or more processors 351 may include one or more processing devices such as, for example, a microprocessor, a microcontroller, an application-specific integrated circuit (ASIC), a field programmable gate array (FPGA) or other type of processing circuitry, as well as portions or combinations of such circuitry elements. API interface 350 can also include non-transitory computer-readable memory with one or more databases and data stored thereon. The memory may comprise electronic memories such as random-access memory (RAM), read-only memory (ROM), or other types of memory, in any combination. Data stored on the memory can include, for example, adaptor data 353. One or more software modules may be stored in the memory and running or configured to run on the one or more processors 351. Such modules can include an adapter reconfiguration module 354, for example. The processes performed by such modules, the data produced thereby and/or the data accessed thereby are described herein.

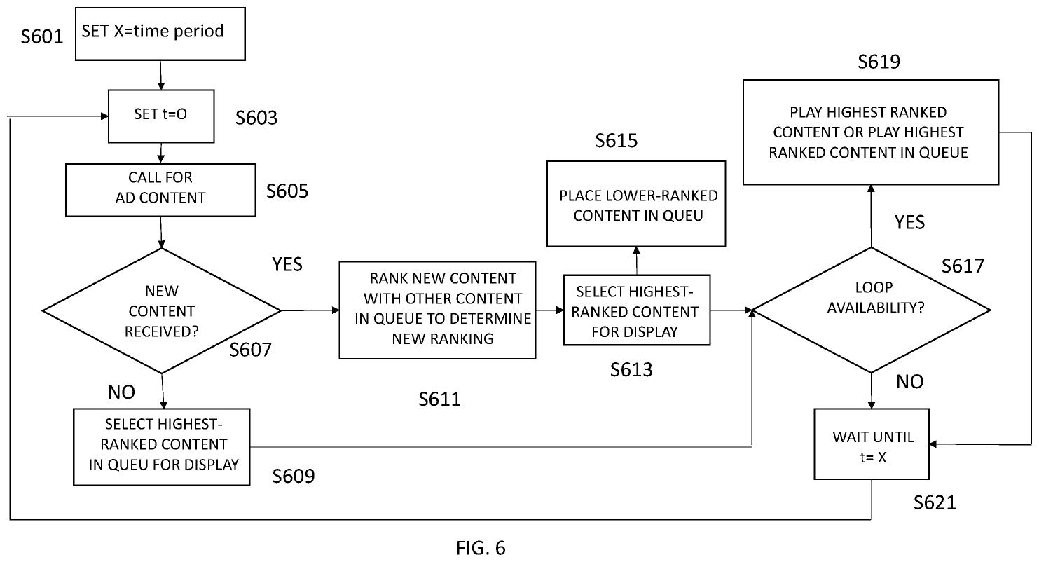

FIG. 8 shows source code for a process of normalizing supply side responses (for example, as performed at step S505 as discussed above) according to an exemplary embodiment of the present invention.

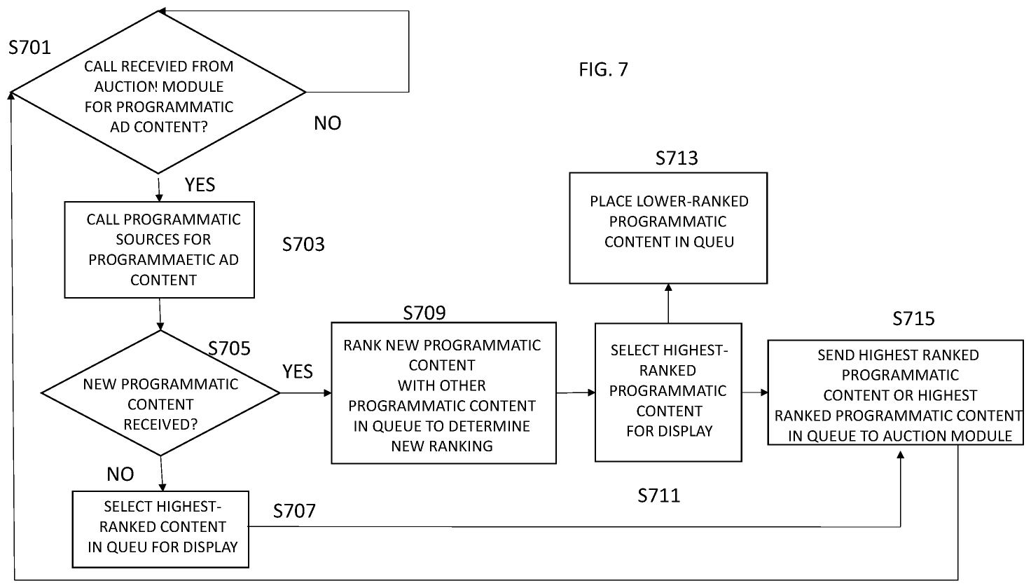

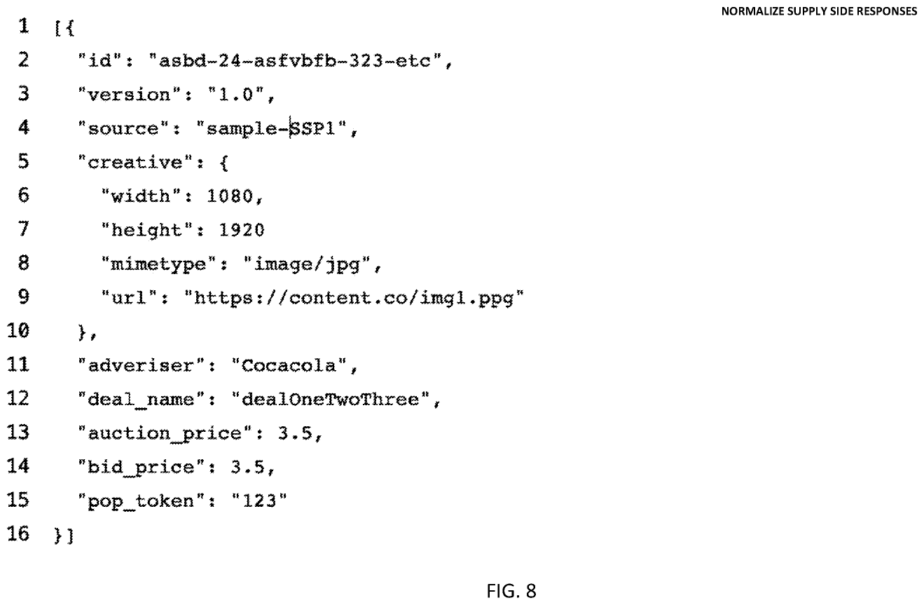

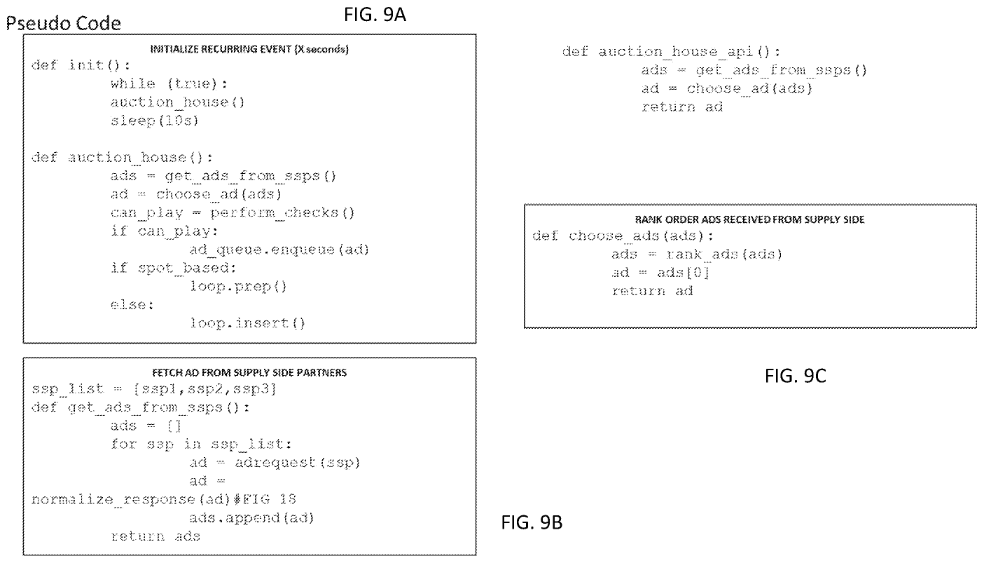

FIG. 9A shows source code for a process for initializing recurring events (for example, as performed in steps S601 and S603 as discussed above) according to an exemplary embodiment of the present invention.

FIG. 9B shows source code for a process of fetching ads from supply side sources (for example, as performed in steps S605 and S703 as discussed above) according to an exemplary embodiment of the present invention.

FIG. 9C shows course code for a process of ranking ads received from supply side sources (for example, as performed in steps S611 and S709 as discussed above) according to an exemplary embodiment of the present invention.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed is:

1. A method comprising:
(A) calling, by one or more computers, a plurality of third party source computer systems on a periodic basis;
(B) determining, by the one or more computers, with each calling in step (A), whether a response to the calling is received;
(C) upon the condition it is determined in step (B) a response is received:
(i) accessing, by the one or more computers, a first plurality of digital advertisements received from the called third party source computer systems;
(ii) ranking, by the one or more computers, based on at least one ranking parameter, the received first plurality of digital advertisements with a prior ranked second plurality of digital advertisements corresponding to one or more of the plurality of third party source computer systems that have responded to a prior calling;
(D) upon the condition it is determined in step (B) that a response is not received, accessing, by the one or more computers, the prior ranked second plurality of digital advertisements corresponding to the one or more of the third party source computer systems that have responded to a prior calling;
(E) determining, by the one or more computers, whether a slot within a first play of looped content at a non-personal digital display is available for display of one of the plurality of digital advertisements, the step of determining comprising:
(i) determining, by the one or more computers, whether the non-personal digital display is under a threshold of played programmatic digital advertisements at a time of the first play of the looped content; and
(ii) determining, by the one or more computers, whether the slot is dedicated to a prior selected digital advertisement at the time of the first play of the looped content;
(F) upon the condition that it is determined in step (E) that a slot is available within the first play of the looped content and it is determined in step (C) that a response is received, generating, by the one or more computers, instructions to display within the slot a highest ranking digital advertisement from among the first plurality of digital advertisements as ranked with the prior ranked second plurality of digital advertisements that has not yet been displayed; and
(G) upon the condition that it is determined in step (E) that a slot is available within the first play of the looped content and it is determined in step (D) that a response is not received, generating, by the one or more computers, instructions to display within the slot a highest ranking digital advertisement from among the prior ranked second plurality of digital advertisements that has not yet been displayed.

2. The method of claim 1, wherein the periodic basis is less than a duration of the first play of the looped content.

3. The method of claim 1, wherein steps (A)-(G) are performed one or more times during the first play of the looped content.

4. The method of claim 1, wherein the at least one ranking parameter comprises a plurality of ranking parameters.

5. The method of claim 1, wherein the at least one ranking parameter comprises a parameter selected from the group consisting of: price, content fitness, pacing goals, and content preference.

6. The method of claim 1, further comprising discarding, by the one or more computers, digital advertisements from the ranked second plurality of digital advertisements.

7. The method of claim 6, wherein the step of discarding comprises:
(i) determining, by the one or more computers, one or more lowest ranked digital advertisements from the prior second plurality of digital advertisements; and
(ii) eliminating, by the one or more computers, the one or more lowest ranked digital advertisements from potential play within the looped content.

8. The method of claim 1, wherein the plurality of third-party source computer systems comprises an advertising server.

9. The method of claim 1, wherein the plurality of third-party source computer systems comprises a third-party programmatic platform.
